(19) United States
(12) Patent Application Publication
(10) Pub. No.: US 2023/0276825 A1
(43) Pub. Date: Sep. 7, 2023

(54) DISCHARGE APPARATUS AND METHOD FOR TEXTURING A FOOD COMPOSITION AND APPARATUS FOR PRODUCING A FOOD COMPOSITION

(71) Applicant: Coperion GmbH, Stuttgart (DE)

(72) Inventors: Christian HÜTTNER, Aichwald (DE); Uta KÜHNEN, Stuttgart (DE); Fabian SPECHT, Stuttgart (DE); Svetlana MARINOVA, Stuttgart (DE); Stefan HUBER, Friolzheim (DE)

(73) Assignee: Coperion GmbH, Stuttgart (DE)

(21) Appl. No.: 18/173,561

(22) Filed: Feb. 23, 2023

(30) Foreign Application Priority Data
Mar. 1, 2022 (DE) 10 2022 202 087.1

(51) Int. Cl. A23J 3/26; A23P 30/20; A23J 3/22

(52) U.S. Cl. CPC A23J 3/26; A23P 30/20; A23J 3/227

(57) ABSTRACT

A discharge apparatus for texturing a food composition, in particular a meat substitute composition, includes a first boundary member having a first texturing surface and a second boundary member having a second texturing surface, a gap formed between the texturing surfaces, at least one feed opening for continuously feeding the food composition into the gap and at least one discharge opening for continuously discharging the food composition from the gap. The first boundary member and the second boundary member are rotatably drivable relative to each other about an axis of rotation. The first texturing surface and the second texturing surface each extend between the respective first feed opening and the at least one discharge opening radially to the axis of rotation.

### CROSS-REFERENCES TO RELATED APPLICATIONS

This application claims the priority of German Patent Application, Serial No. DE 10 2022 202 087.1, filed Mar. 1, 2022, the content of which is incorporated herein by reference in its entirety as if fully set forth herein.

### FIELD

The present disclosure relates to a discharge apparatus for texturing a food composition, in particular a meat substitute composition. The disclosure also relates to a facility for producing a food composition, in particular a meat substitute composition, having a discharge apparatus of this type. The disclosure further relates to a method for texturing a food composition, in particular a meat substitute composition.

### BACKGROUND

The texture of a food product has a significant influence on the taste and sense of enjoyment when the food is consumed. In the industrial production of substitute products, an attempt is therefore made to texture a food composition in such a manner that its texture comes as close as possible to the texture of the food to be substituted. In the production of meat substitute products in particular, attempts are made to imitate the bite and chewing behavior of meat. For example, meat substitute compositions are subjected to a so-called wet texturing process in which fiber-like structures are formed. Wet texturing can be performed continuously or in a batch method. For continuous texturing, cooling nozzles are used, for example, through which an extruded food composition is cooled and prevented from expanding. The disadvantage of this is the strong dependence of the resulting fiber structure on the specific process parameters, which makes it difficult to scale up the process.

### SUMMARY

It is an object of embodiments of the present disclosure to improve a discharge apparatus for the continuous texturing of a food composition, and in particular to provide a discharge apparatus which allows accurate and precise adjustment of texturing and which is scalable.

This object is achieved by a discharge apparatus for texturing a food composition, in particular a meat substitute composition comprising
a first boundary member having a first texturing surface,
a second boundary member having a second texturing surface,
a gap formed between the first texturing surface and the second texturing surface,
at least one feed opening for continuously feeding the food composition into the gap, and
at least one discharge opening for continuously discharging the food composition from the gap, wherein the first boundary member and the second boundary member are rotatably drivable relative to each other about an axis of rotation, and wherein the first texturing surface and the second texturing surface each extend radially to the axis of rotation between the at least one feed opening and the at least one discharge opening. The discharge apparatus includes a first boundary member having a first texturing surface and a second boundary member having a second texturing surface. A gap is formed between the first texturing surface and the second texturing surface. The discharge apparatus further has at least one feed opening for continuously feeding the food composition into the gap and at least one discharge opening for continuously discharging the food composition from the gap. The first boundary member and the second boundary member are rotatably drivable relative to each other about an axis of rotation. The first texturing surface and the second texturing surface each extend between the at least one feed opening and the at least one discharge opening radially to the axis of rotation. The food composition, continuously fed through the at least one feed opening, is continuously passed through the gap to the at least one discharge opening. The food composition interacts with the texturing surfaces so that a velocity profile is created. Thus, due to the passage of the food composition through the gap, a first shear force acts on the food composition. Due to the relative rotational drive of the boundary members, a further second shear force is exerted on the food composition. Since the texturing surfaces extend from the at least one feed opening to the at least one discharge opening radially to the axis of rotation, the first shear force and the second shear force act in different directions. In particular, the first shear force acts in a radial direction, whereas the second shear force acts in particular in a circumferential direction. The second shear force can be generated in a controlled manner and independently of the first shear force. In particular, the shear force generated by the relative rotational movement of the boundary members can be easily adapted to the respective case of application in a controlled manner. In particular, the generated shear force can be precisely adjusted independently of a product flow rate, for example by varying the rotational speed and/or a gap dimension of the gap. The discharge apparatus can be used flexibly and is scalable.

Another advantage is that the shear force is locally adjustable, in particular variable. With relative rotational drive of the boundary members, the relative surface speed of the texturing surfaces increases with growing distance to the axis of rotation. This can be used to change the shear depending on the position, in particular to increase it. For example, a shear force that increases with the radial distance from the axis of rotation can be generated at a constant gap dimension. Additionally or alternatively, a gap dimension can be dependent on the distance to the axis of rotation in order to counteract an increase in shear forces due to the increased surface speed or to further increase the shear forces. Advantageously, particularly high shear forces and/or homogeneous shear forces can be generated in this manner. The discharge apparatus allows a flexible and easily scalable texturing process.

In embodiments, the axis of rotation runs in the direction of gravity. Gravity does not influence the passage of the food composition through the gap in the direction perpendicular to the axis of rotation. The texturing is homogeneous and precisely controllable.

The discharge apparatus is suitable for texturing any food composition. The discharge apparatus is particularly suitable for texturing meat substitute compositions. The precisely adjustable shear force allows a defined creation of fiber structures. The meat substitute composition can be, for example, a protein melt, in particular a so-called High Moisture Meat Analogue (HMMA). A meat substitute composition may include, for example, water, vegetable proteins, in particular soy proteins and/or wheat proteins, binders, in particular starch and/or flour, vegetable oils and/or vegetable fats and/or flavorings. Exemplary meat substitute compositions in the form of HMMA and their preparation are described in EP 3 270 716 B1.

In embodiments, the texturing surfaces of the two boundary members are spaced apart in the direction of the axis of rotation. An extension of the texturing surfaces in the direction perpendicular to the axis of rotation, in particular a diameter of the texturing surfaces perpendicular to the axis of rotation, can be easily and flexibly adapted. A gap dimension of the gap formed by the spacing of the texturing surfaces in the direction of the axis of rotation is easily and flexibly adaptable. An expansion of the food composition fed into the gap is precisely and flexibly adjustable. The discharge apparatus is easily scalable.

A gap dimension of the gap, in particular in the direction of the axis of rotation, can be between 5 mm and 20 mm, in particular between 8 mm and 15 mm, for example approx. 10 mm. The gap dimension is variable in embodiments.

The first texturing surface and the second texturing surface each extend radially to the axis of rotation between the at least one feed opening and the at least one discharge opening. In embodiments, the first texturing surface and the second texturing surface extend continuously along the axis of rotation. Changes of direction that would be detrimental to the material guidance, in particular edges, are avoided. The advantage of the adjustable shear forces can be implemented to a particularly high degree due to the continuous extension in the radial direction.

In embodiments, the discharge apparatus has at least one feed opening. The at least one feed opening is designed or arranged concentrically to the axis of rotation. For example, a single feed opening can be formed in the region of the axis of rotation. The feed opening may, for example, have a circular cross-section. A diameter of the feed opening can be between 15 mm and 80 mm, in particular between 17.5 mm and 50 mm, for example about 20 mm.

The discharge apparatus has one or more discharge openings. In embodiments, the at least one discharge opening is designed or arranged concentrically to the axis of rotation and/or is designed to be ring-shaped and/or ring-section-shaped.

The first boundary member and the second boundary member are rotationally drivable relative to each other, in particular with variable rotational direction and rotational speed in embodiments. Particularly, in embodiments, only one of the two boundary members is driven, while the other is stationary. The design of the discharge apparatus is structurally simple and reliable.

In embodiments, the first boundary member and/or the second boundary member are rotationally symmetrical with respect to the axis of rotation. A rotational symmetry of the first boundary member and/or the second boundary member may be a discrete rotational symmetry or a continuous rotational symmetry. The texturing of the food composition is homogeneous. An energy input for the relative rotational drive of the boundary members is low.

In embodiments, the first boundary member and/or the second boundary member are substantially formed as a body of rotation about the axis of rotation. For example, the first boundary member and/or the second boundary member can be formed as a circular plate and/or cone around the axis of rotation.

A discharge apparatus configured such that the first texturing surface and/or the second texturing surface extend at an angle b to the axis of rotation, wherein 45°≤b≤90°, in particular 60°≤b≤90°, in particular 75°≤b≤90°, in particular 80°≤b≤90°, in particular 85°≤b≤90°, in particular 87°≤b≤90°, is particularly flexible and easily scalable. The angle b at which the first texturing surface and/or the second texturing surface extend relative to the axis of rotation is the angle that a surface tangent of the respective texturing surface encloses with the axis of rotation. For example, an angle b of 45° means that the respective texturing surface encloses an angle of 45° with the axis of rotation. With an angle b of at least 45°, the texturing surfaces extend essentially in the radial direction. The advantages of texturing surfaces extending in the radial direction are given to a considerable extent, in particular the shear force generated by means of the relative rotation of the boundary members can be varied over a wide range. For example, the angle b can be about 90°. The texturing surface runs essentially in a normal plane of the axis of rotation.

In embodiments, the angle b at which the first texturing surface and/or the second texturing surface run to the axis of rotation is independent of an angular coordinate defined around the axis of rotation. For example, the angle b can be the same in all directions that are perpendicular to the axis of rotation. In particular, the angle b can be substantially constant over the entire first texturing surface and/or over the entire second texturing surface.

In embodiments, the first boundary member and/or the second boundary member are substantially formed as a body of rotation about the axis of rotation. The first texturing surface and/or the second texturing surface extends in all directions that are perpendicular to the axis of rotation essentially at the same angle b to the axis of rotation.

For example, the first texturing surface and/or the second texturing surface extend substantially in a normal plane of the axis of rotation. The first texturing surface and/or the second texturing surface may extend in particular perpendicularly, in particular radially to the axis of rotation. For example, the first texturing surface and/or the second texturing surface may have a circular shape that is substantially arranged concentrically with respect to the axis of rotation. The first boundary member and/or the second boundary member can accordingly be designed as a plate, in particular as a circular plate.

A discharge apparatus configured such that the first texturing surface and the second texturing surface run parallel to one another is structurally simple and enables precise adjustment of the gap dimension. In embodiments, the gap dimension can be adjusted by vertically advancing one boundary member relative to the other boundary member.

Texturing surfaces that run parallel have a constant gap dimension, in particular. The shear force generated by the relative rotational drive of the boundary members increases with growing radial distance from the axis of rotation. The parallel texturing surfaces therefore have the particular advantage of a simply and effectively variable shear force for texturing the food composition.

For example, the first texturing surface and the second texturing surface may be formed to be substantially flat. In particular, the first texturing surface and the second texturing surface are configured to be perpendicular to the axis of rotation. The boundary members may, for example, each be in the form of plates, in particular circular plates.

A discharge apparatus configured such that a gap dimension of the gap changes depending on a distance to the axis of rotation, in particular increases with growing distance to the axis of rotation, allows a particularly flexible adjustment of the shear forces. The varying gap dimension influences the shear forces acting on the food composition. In this manner, for example, an increase in the shear forces due to the larger radial distance can be compensated for or intensified.

In particular, the gap dimension increases with growing distance from the axis of rotation. As a result, an increase in shear forces due to the higher surface speed with a larger radius can be counteracted. For example, the gap dimension increases such that the shear forces acting on the food composition are independent of the distance to the axis of rotation. This enables a homogeneous effect of the shear forces.

A varying gap dimension, in particular a gap dimension that increases as the distance from the axis of rotation grows, also enables the distribution of the food composition in the gap to be influenced in a targeted manner. For example, the gap dimension in the region of the at least one feed opening can be reduced in order to generate a counterpressure. In this manner, the food composition can be directed into the regions of larger gap dimension in a targeted manner. This favors a homogeneous distribution and texturing of the food composition.

For example, at least one of the boundary members can be designed to be conical. The corresponding texturing surface corresponds to the circumferential surface of the cone. For example, one of the boundary members may be formed as a cone. The other boundary member can be designed as a plate and/or a cone. In the event that both boundary members are formed as a cone, they may be oriented in the same or opposite directions in the direction of the axis of rotation.

A discharge apparatus configured such that the at least one discharge opening has a greater distance to the axis of rotation than the at least one feed opening is efficient and particularly suitable for texturing a food composition. The food composition that is introduced into the gap via the at least one feed opening passes through the gap in a radially outward direction. The space that is available in the gap for the food composition therefore increases from the at least one feed opening to the at least one discharge opening. This promotes the expansion of the food composition, which loosens the texture thereof.

A greater distance of the at least one discharge opening to the axis of rotation also has the advantage that a centrifugal force resulting from the relative rotation of the boundary members promotes the expansion of the food composition in the direction of the at least one discharge opening. The expansion of the food composition can therefore be specifically influenced by the speed of rotation. In particular, as the rotational speed increases, the pressure in the region of the at least one feed opening can be reduced. This favors the formation of steam bubbles, which can contribute to a further loosening of the texture.

A discharge apparatus configured such that the at least one discharge opening is formed for discharging the food composition in the direction radial to the axis of rotation, in particular is formed circumferentially between the first boundary member and the second boundary member is constructively simple and efficient. The discharge direction corresponds essentially to the direction in which the food composition passes through the gap. A deflection of the food composition in the region of the at least one discharge opening is advantageously avoided. A texture that is produced in the food composition, in particular a fiber structure, is not influenced, in particular not damaged, by the discharge through the at least one discharge opening. An accumulation in the region of the at least one discharge opening is avoided.

In embodiments, the at least one discharge opening is formed circumferentially between the first boundary member and the second boundary member. For example, the gap that is formed between the texturing surfaces can have openings that are arranged on the circumferential side, in particular can be open on the circumferential side. The discharge apparatus is of simple construction. The discharge opening that is formed on the circumferential side can also be covered by a closure member that is arranged on the circumferential side. One or more openings for discharging the food composition may be formed in the closure member. This ensures in particular that the food composition is discharged at a precisely defined location.

A discharge apparatus comprising at least one wiper device in the region of the at least one discharge opening enables an easy separation and portioning of the textured food composition. For example, the at least one wiper device can be arranged at one of the two boundary members, in particular at a fixed boundary member. This allows the food composition to be separated at a precisely defined location. This is particularly advantageous in the event of a circumferentially formed discharge opening.

A discharge apparatus comprising at least one texturing tool arranged in the gap is particularly versatile. The product shape and texture can be effectively influenced by the at least one texturing tool that is arranged in the gap. For example, a flow of the food composition can be directed and/or divided. With the aid of the at least one texturing tool, further mixing of the food composition can alternatively or additionally take place. The at least one texturing tool comprises in particular baffle plates, projections, for example in the form of pins and/or cones, rakes, grids, filters and/or sieves.

For example, the at least one texturing tool can have baffle plates. In embodiments, the baffle plates are arranged spirally around the at least one feed opening, in particular spirally around a feed opening that is arranged concentrically to the axis of rotation. With the aid of baffle plates, in particular spirally arranged baffle plates, the product shape of the food composition that is to be discharged can be influenced in a targeted manner, in particular depending on the direction of rotation. For example, the food composition can be formed into a bar shape when the direction of rotation corresponds to the spiral direction of the baffle plates. In the opposite direction of rotation, i.e. in the direction opposite to the spiral direction of the baffle plates, the baffle plates lead to further comminution of the food composition. This results in a small-particle, in particular torn, structure.

Additionally or alternatively, the at least one texturing tool can cause a tapering and/or widening of the gap. For example, the at least one texturing tool can lead to a tapering of the gap in the region of the at least one feed opening. The tapering causes a counterpressure against the continuously introduced food composition. The counterpressure favors a homogeneous distribution of the food composition in the gap. For example, the at least one texturing tool may be configured as a protrusion opposite the at least one feed opening, in particular as a conical protrusion opposite the at least one feed opening.

The at least one texturing tool can alternatively or additionally also have closure means for closing off regions of the at least one discharge opening. This can generate a counterpressure against the food composition to be discharged. In addition, a defined discharge of the food composition can be achieved by the at least regional closure of the at least one discharge opening. Suitable texturing tools can, for example, have closure members, in particular closure plates.

The at least one texturing tool can be arranged, in particular fastened, to the first boundary member and/or the second boundary member. The at least one texturing tool may in particular be part of at least one boundary member. For example, the at least one texturing tool may be attached or attachable to a boundary member main body of at least one of the boundary members.

A discharge apparatus configured such that the at least one texturing tool is detachably arranged at the first boundary member and/or at the second boundary member is particularly versatile and flexible in use. The detachable arrangement of the at least one texturing tool at the first boundary member and/or the second boundary member facilitates cleaning and maintenance of the discharge apparatus, in particular of the at least one texturing tool. Due to the detachable arrangement, the at least one texturing tool is also exchangeable. Depending on the application, different texturing tools can therefore be used.

In embodiments, the at least one texturing tool is insertable as an insert in a boundary member main body of at least one of the two boundary members.

A discharge apparatus comprising a temperature control unit for temperature control of the first boundary member and/or the second boundary member is efficient and versatile. The temperature control unit can be used for temperature control, in particular cooling, of the food composition. A separate, in particular subsequent, cooling of the discharged and textured food composition is not necessary. In embodiments, the temperature control unit is used for temperature control, in particular for cooling, of the first boundary member and the second boundary member.

With the aid of the temperature control unit, a food composition in the form of a melt, for example a protein melt, can be cooled and hardened during texturing.

The temperature control unit, in embodiments, has temperature control channels for a temperature control medium, in particular a cooling medium, in the first boundary member and/or the second boundary member. In embodiments, the temperature control medium, in particular the cooling medium, can be conveyed through the temperature control channels in the first boundary member and/or the second boundary member. This enables active temperature control, in particular active cooling, of the food composition in the gap. The temperature control unit may include a reservoir for a temperature control medium, a temperature control apparatus for controlling the temperature of the temperature control medium and/or a pump for conveying the temperature control medium. Alternatively, it is also possible that the temperature control unit of the discharge apparatus has connections for feeding and/or discharging a temperature control medium. The temperature control medium can be provided outside the discharge apparatus, for example by means of an external reservoir, an external temperature control apparatus and/or an external pump.

For example, feeding and discharging of the temperature control medium to the first boundary member and/or the second boundary member can be implemented via milled and/or welded channels. This is particularly advantageous for a stationary boundary member. A boundary member that can be driven in rotation can be equipped accordingly with a supply and discharge for temperature control media, for example by providing a rotary feedthrough for the respective supply and discharge channel.

In embodiments, both boundary members have temperature control channels for the temperature control medium, in particular the cooling medium. In embodiments, the temperature control channels of different boundary members are separate from each other. For example, a temperature control medium, in particular a cooling medium, can be conveyed in counterflow or co-flow through temperature control channels that are formed in the respective boundary members. This enables adjustable, in particular independent temperature control, in particular cooling, of the boundary members.

Suitable temperature control media, in particular cooling media, may for example include water and/or glycols, in particular propylene glycol and/or ethylene glycol. The temperature control medium can, for example, be controlled to a temperature T, wherein: 10° C.≤T≤100° C., in particular 15° C.≤T≤90° C., in particular 20° C.≤T≤70° C. This enables gentle cooling of a food composition, in particular in the form of a melt, for example a protein melt. Too rapid cooling and a risk of the melt sticking to the texturing surfaces is reduced, in particular avoided. Gentle cooling of the food composition is also beneficial to its texture. Excessive cooling is detrimental to the texture quality; in particular, excessive cooling can result in an unwanted crumbly texture.

A discharge apparatus configured such that the temperature control unit controls the temperature of a temperature control region of the first texturing surface and/or of the second texturing surface, wherein the temperature control region has a temperature control area Ak for which applies: 40 cm²/(kg/h)≤Ak/m≤1,000 cm²/(kg/h), in particular 200 cm²/(kg/h)≤Ak/m≤800·cm²/(kg/h), in particular 300 cm²/(kg/h)≤Ak/m≤600 cm²/(kg/h), wherein m is the hourly flow rate of the food composition in kilograms, is particularly flexibly scalable. The temperature control area Ak is selected in such a manner that gentle temperature control is ensured regardless of the product flow rates. This increases the product quality and reduces rejects. In embodiments, the temperature control area corresponds essentially to the first texturing surface and/or the second texturing surface. This enables a space-saving structure of the apparatus.

A discharge apparatus configured such that the temperature control unit is designed for different temperature control of different temperature control subregions of the first texturing surface and/or of the second texturing surface, in particular for temperature control of the first texturing surface and/or of the second texturing surface in dependence on a distance from the axis of rotation, enables a particularly flexible and application-specific temperature control. Different temperature control zones, in particular different cooling zones, can be defined by the different temperature control subregions. This allows a temperature profile to be generated on the first texturing surface and/or the second texturing surface. In embodiments, the temperature profile is formed in a radial direction, in particular in the direction from the at least one feed opening to the at least one discharge opening. For example, the temperature profile may cause an increasing cooling between the at least one feed opening and the at least one discharge opening. This ensures increasing cooling and hardening of the food composition without it sticking, in particular freezing, to the texturing surfaces. Different temperature control zones, in particular different cooling zones, can in particular have a different radial distance from the axis of rotation.

Different temperature control subregions can advantageously also be used for alternate cooling and heating of the food composition. This enables further preparation of the food composition during texturing.

Different temperature control zones can, for example, be flowed through by a temperature control medium, in particular a cooling medium, in cross flow, in counter flow or in co-flow. It is also possible to cool one or more temperature control zones in an open water bath.

In order to form different temperature control subregions, these can, for example, have different arrangements and/or geometries of temperature control channels. For example, temperature control channels of different cross-sections can be arranged in different temperature control subregions. In this manner, different amounts of temperature control medium can flow through the respective temperature control channels, in particular be pumped around. It is also possible that the temperature control channels are arranged differently in different temperature control subregions. For example, a distance between temperature control channels may be greater in one temperature control subregion than in another.

A discharge apparatus configured such that the first texturing surface and/or the second texturing surface have a surface profiling, in particular a corrugation, enables efficient texturing of the food composition. The surface profiling, in particular the corrugation, can influence the effect of the shear forces on the food composition. The surface profiling, in particular the corrugation, can also produce a surface texturing of the food composition.

A discharge apparatus comprising at least one supply line for continuously supplying the food composition to the at least one feed opening is particularly flexible. By means of the at least one supply line, the discharge apparatus can be flexibly connected to common preparation devices, for example extruders. A direct connection is not necessary. The discharge apparatus can be easily connected to existing discharge devices. In particular, the supply line can serve as an adapter. By means of the supply line, in particular a flow direction of the food composition to be supplied can be influenced. For example, a food composition that is conveyed in a horizontal direction in an extruder can be guided by means of the supply in such a manner that it enters the gap of the discharge apparatus in a vertical direction.

The at least one supply line can in particular be designed as a pipe. A pipe diameter of the at least one supply line can correspond to a diameter of the at least one feed opening. For example, the following may apply to a pipe diameter Dz: 15 mm≤Dz≤100 mm, in particular 17.5 mm≤Dz≤50 mm. An exemplary pipe diameter Dz may, for example, be approximately 20 mm.

In embodiments, the at least one supply line is temperature-controllable. This allows the food composition that is supplied in the supply line to be pre-tempered. In particular, unintentional cooling or hardening of the food composition in the supply line is avoided.

The at least one supply line can in particular have further fixtures, for example orifices and/or static mixers. This allows a fluid flow of the food composition to be influenced in a targeted manner A segregation of components of the food composition is avoided.

A discharge apparatus comprising at least one additional access opening for the admixture of further ingredients and/or for monitoring the food composition is particularly versatile and flexible in use. Through the at least one additional access opening, further ingredients can be fed into the food composition, for example vegetable oil. In particular, it is possible to prepare different components of the food composition independently of each other, in particular to extrude them independently of each other, and to combine them in the discharge apparatus. This enables a joint discharge of co-extruded components of the food composition.

Sensors for monitoring the fluid flow of the food composition can also be inserted by means of the at least one additional access opening. For example, a temperature, density and/or composition of the food composition can be monitored therewith. This allows an early reaction to production problems and avoids rejects.

In embodiments, the at least one additional access opening is arranged in at least one supply line. Ingredients to be admixed can already be fed in the region of the supply line. The admixture can be easily controlled by means of fixtures in the at least one supply line, for example in the form of orifices. Additionally or alternatively, mixing in of the admixed ingredients is possible via fixtures of the at least one supply line, for example in the form of static mixers. By means of at least one additional access opening, sensory monitoring of the food composition in the at least one supply line is additionally or alternatively possible. This enables a particularly fast and reliable reaction to possible deviations of the food composition from a target dimension.

Additionally or alternatively, the discharge apparatus can have at least one additional access opening to the gap. Via the at least one additional access opening to the gap, one or more further components of the food composition can, for example, be introduced directly into the gap, in particular be fed continuously. This enables a targeted metered addition of further components of the food composition during the discharge. The at least one additional access opening to the gap can, for example, be formed as a through opening in one of the boundary members, in particular in a stationary boundary member.

It is another object of embodiments of the present disclosure to improve a facility for the production of food compositions, in particular meat substitute compositions.

This object is achieved by a facility for the production of a food composition, in particular a meat substitute composition, comprising:
at least one preparation apparatus for continuously preparing the food composition and
a discharge apparatus for texturing the food composition according to the disclosure, wherein at least one outlet opening of the at least one preparation apparatus is connected to the at least one feed opening of the discharge apparatus. The facility has at least one preparation apparatus for continuously preparing the food composition and a discharge apparatus for texturing the food composition. At least one outlet opening of the at least one preparation apparatus is connected to the at least one feed opening of the discharge apparatus, in particular in fluid connection. The facility has the advantages obtained with the discharge apparatus described above. The discharge apparatus is embodied as described above and may in particular have one or more of the advantageous features described above.

The at least one outlet opening is connected to the discharge apparatus, for example, via at least one supply line of the discharge apparatus.

In particular, the facility can have multiple preparation apparatuses for the continuous preparation of the food composition. For example, different components of the food composition can be prepared in parallel and fed together to the discharge apparatus. For example, co-extrusion of different components of the food composition is possible.

The at least one preparation apparatus includes in particular an extruder, a multi-screw extruder in embodiments or a twin-screw extruder in embodiments. Extruders, in particular twin-screw extruders, have proven to be suitable for the continuous preparation of food compositions, in particular meat substitute compositions.

It is a further object of embodiments of the disclosure to improve a method for texturing a food composition, in particular a meat substitute composition.

This object is achieved by a method for texturing a food composition, in particular a meat substitute composition, comprising the steps of:
providing a discharge apparatus, comprising
   a first boundary member having a first texturing surface,
   a second boundary member having a second texturing surface,
   a gap formed between the first texturing surface and the second texturing surface,
   at least one feed opening to the gap, and
   at least one discharge opening from the gap,
   wherein the first boundary member and the second boundary member are rotatably drivable relative to each other about an axis of rotation,
   wherein the first texturing surface and the second texturing surface each extend radially to the axis of rotation between the at least one feed opening and the at least one discharge opening,
continuously feeding a food composition to be textured into the gap of the discharge apparatus via the at least one feed opening,
rotationally driving the first boundary member and the second boundary member relative to each other to produce shear forces on the food composition located in the gap to texture it,
continuously discharging the textured food composition via the at least one discharge opening.

A discharge apparatus is provided. The discharge apparatus has a first boundary member including a first texturing surface, a second boundary member including a second texturing surface, a gap formed between the first texturing surface and the second texturing surface, at least one feed opening to the gap, and at least one discharge opening from the gap. The first boundary member and the second boundary member are rotatably drivable relative to each other about an axis of rotation. The first texturing surface and the second texturing surface each extend between the at least one feed opening and the at least one discharge opening radially relative to the axis of rotation. A food composition to be textured is continuously fed into the gap via the at least one feed opening and forwarded to the discharge opening. The first boundary member is rotationally driven relative to the second boundary member to generate shear forces on the food composition located in the gap for the texturing thereof. The textured food composition is continuously discharged through the at least one discharge opening. The method is flexibly adjustable and scalable. In particular, the method has the advantages described with respect to the discharge apparatus described above. The discharge apparatus provided may have one or more of the optional features described above.

The food composition to be textured, in particular a meat substitute composition, can be prepared, in particular continuously prepared, before being fed into the gap. For example, the food composition can be continuously prepared in an extruder and supplied to the discharge apparatus. It is also possible to prepare different components of the food composition independently of each other and to combine them in the discharge apparatus, in particular in at least one supply line of the discharge apparatus. For example, different components of the food composition can be extruded in different extruders and brought together in the discharge apparatus, in particular in at least one supply line of the discharge apparatus.

A method in which the first boundary member and the second boundary member are rotationally driven relative to each other such that for a relative rotational speed n: 0·1/min<n≤40·1/min, in particular 5·1/min≤n≤20·1/min, has been shown to be particularly suitable for texturing food compositions, in particular meat substitute compositions. An exemplary rotational speed may be about 10·1/min. In embodiments, the rotational speed is variable.

In particular, one boundary member can be stationary. The relative rotational movement can then be generated by rotational drive of the other boundary member. Then the relative rotational speed corresponds to the absolute rotational speed of the rotationally driven boundary member. The rotational drive of only one boundary member is simple and reliable.

A method in which a direction of rotation with which the first boundary member and the second boundary member are driven in rotation relative to each other is inverted during the discharge process, in particular is inverted repeatedly, allows a particularly strong influence on texturing. By inverting the direction of rotation, fiber structures can be formed in different directions. Furthermore, a loosening of the texture can be obtained by one or more changes of the direction of rotation. For example, the change in the direction of rotation can cause the food composition to tear or unravel.

The change in the direction of rotation is particularly efficient in conjunction with at least one texturing tool, in particular at least one texturing tool in the form of at least one baffle plate. For example, the influence on the direction of rotation and/or its inversion can be increased by arranging baffle plates in a certain direction, for example by arranging the baffle plates in a spiral.

A method in which the food composition is fed at a pressure p via the feed opening, wherein the following applies to the pressure p: 0 bar<p≤50 bar, in particular 1 bar≤p≤35 bar, in particular 3 bar≤p≤20 bar, has proven to be particularly suitable. With common preparation devices, in particular common extruders, corresponding conveying pressures can be generated. Depending on the pressure and the desired texturing, for example, the relative rotational speed of the boundary members can be adapted.

A method in which the textured food composition is discharged at a flow rate m via the at least one discharge opening, wherein: 10 kg/h≤m≤2,000 kg/h, in particular 20 kg/h≤m≤1,000 kg/h, in particular 30 kg/h≤m≤500 kg/h, is easily and flexibly scalable. In embodiments, a larger texturing surface of the boundary members can be selected for a higher flow rate. This ensures sufficient texturing even at high flow rates. In particular, the texturing surface can be used to scale a temperature control area. For example, texturing can be performed at a flow rate of about 20 kg/h, about 400 kg/h or about 2,000 kg/h.

A method in which different temperature control subregions of the first texturing surface and/or of the second texturing surface are controlled differently, in particular in dependence on a distance from the axis of rotation, can be used in a particularly flexible manner By varying the temperature of different temperature control subregions, the food composition can be progressively cooled and solidified. Alternatively or in addition thereto, alternating cooling and heating may take place. In embodiments, a temperature gradient is generated in the direction from the at least one feed opening to the at least one discharge opening, in particular in the radial direction.

Further features, advantages and details of the disclosure will be apparent from the following description of an embodiment example based on the figures.

### BRIEF DESCRIPTION OF THE FIGURES

FIG. 1 shows a side view of a facility for the production of a food composition including a preparation apparatus and a discharge apparatus connected thereto,

FIG. 2 shows a longitudinal section through the facility according to FIG. 1,

FIG. 3 shows a perspective view of the discharge apparatus of the facility according to FIG. 1,

FIG. 4 shows a top view onto the discharge apparatus according to FIG. 3,

FIG. 5 shows a side view of the discharge apparatus according to FIG. 3,

FIG. 6 shows a longitudinal section through the discharge apparatus along a section line VI-VI in FIG. 5,

FIG. 7 shows an insert for a boundary member of the discharge apparatus according to FIG. 3 having a texturing tool which includes baffle plates,

FIG. 8 shows a side view of a further insert for a boundary member of the discharge apparatus according to FIG. 3 having a cone-shaped texturing tool,

FIG. 9 shows a cross-section through an exemplary boundary member having a temperature control channel formed therein,

FIG. 10 shows a cross-section through an exemplary boundary member having temperature control channels formed therein, and

FIG. 11 shows a longitudinal section through boundary members of a further embodiment example of a discharge apparatus.

### DETAILED DESCRIPTION

A facility 1 for producing a food composition has a preparation apparatus 2 and a discharge apparatus 3. The facility 1 serves for the production of a meat substitute composition, in particular a High Moisture Meat Analogue (HMMA).

The preparation apparatus 2 includes an extruder 4 for the continuous preparation of the food composition. The extruder 4 is a twin screw extruder. The extruder 4 comprises a housing with housing bores formed therein, in which bores a respective screw shaft 5 is mounted so as to be rotatably drivable. Raw ingredients of the food composition can be fed to the extruder 4 via a metering apparatus 6. The supplied raw ingredients are heated in the extruder 4 and conveyed and mixed by means of the screw shafts 5. By means of admixing apparatuses 7, further components of the food composition, for example vegetable oil and/or flavorings, can be admixed along the conveying path of the screw shafts 5.

The prepared food composition is conveyed through an outlet opening 8 of the extruder 4. A supply line 9 of the discharge apparatus 3 is connected to the outlet opening 8 of the extruder 4. The supply line 9 is designed as a pipeline and connects a feed opening 10 of the discharge apparatus 3 to the outlet opening 8 of the extruder 4. The food composition exits the extruder 4 via the outlet opening 8 as a heated melt, in particular as a protein melt. The protein melt is conveyed in the extruder 4 in a horizontal direction. The supply line 9 can be used to redirect the direction of flow of the melt. With the aid of the supply line 9, the preparation apparatus 2 and the discharge apparatus 3 can be arranged flexibly in relation to each other. The supply line 9 can serve as an adapter between the outlet opening 8 of the extruder 4 and the feed opening 10 of the discharge apparatus 3.

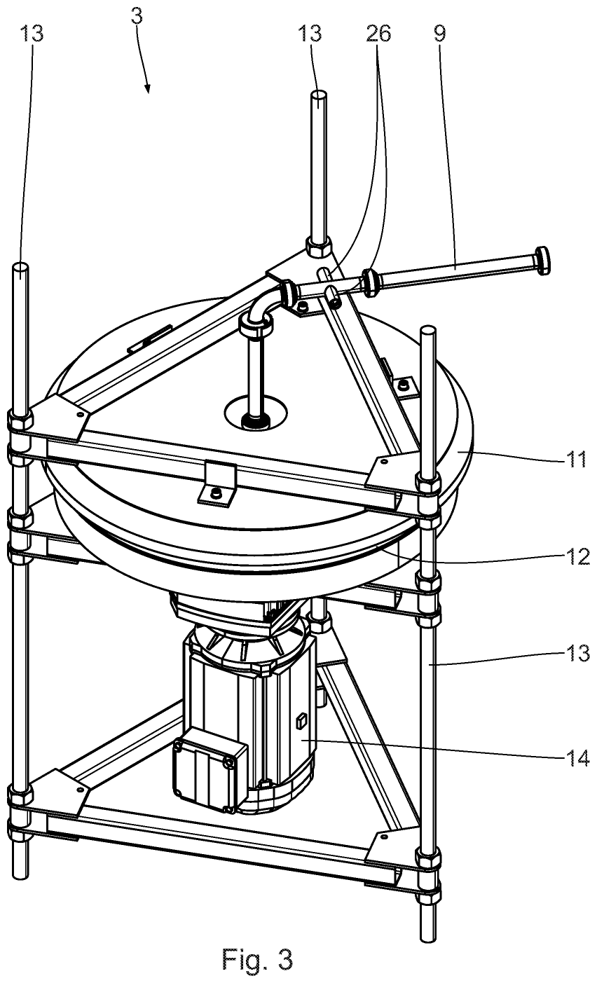

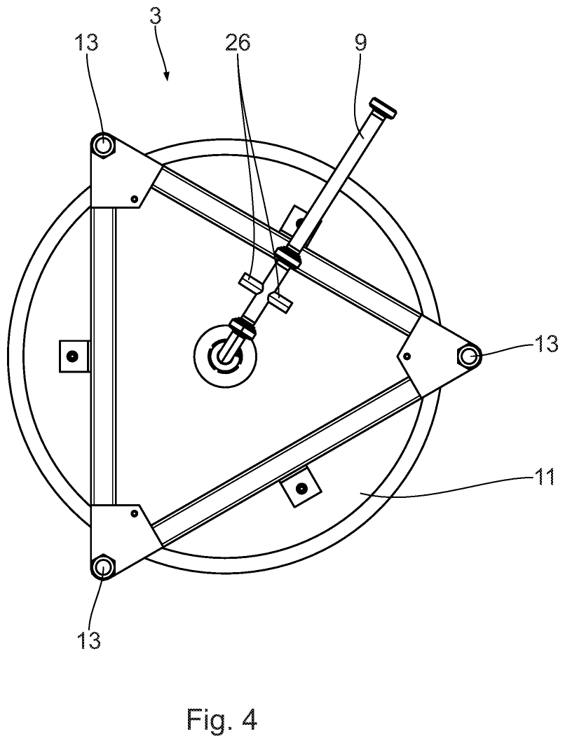

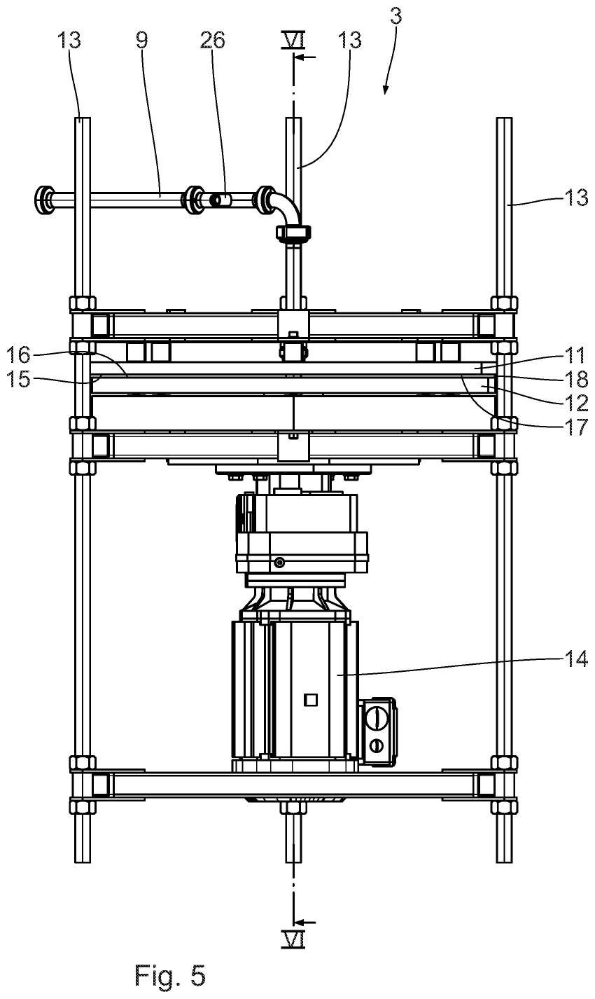

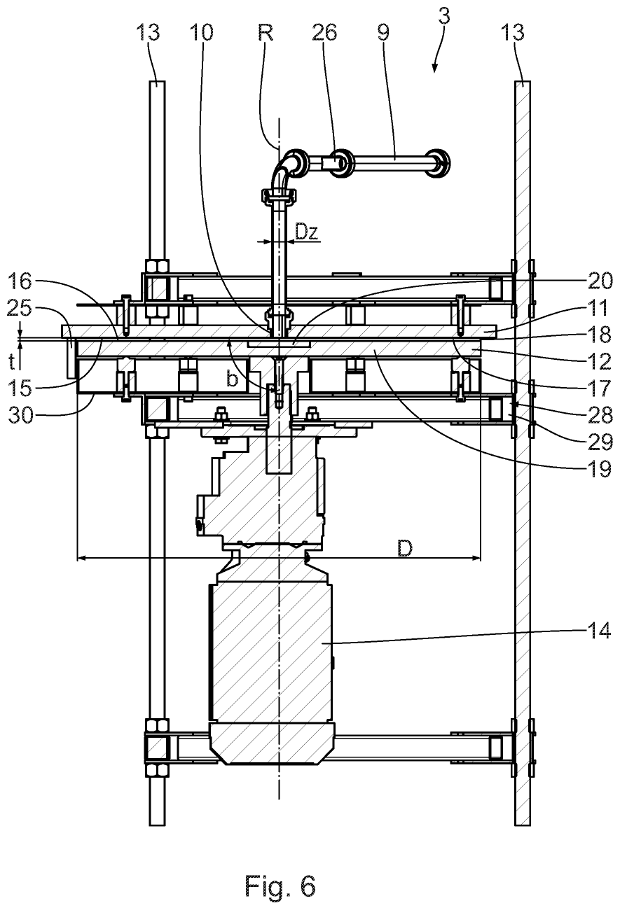

In the following, the discharge apparatus 3 is described in detail with reference to FIGS. 3 to 6.

The discharge apparatus 3 has a first boundary member 11 and a second boundary member 12. The first boundary member 11 is non-rotatably arranged at a support frame 13 of the discharge apparatus 3. The second boundary member 12 can be driven in rotation about an axis of rotation R by means of a rotary drive 14. The two boundary members 11, 12 can be driven in rotation relative to each other by means of the rotary drive 14.

The boundary members 11, 12 are each in the form of circular plates arranged concentrically with respect to the axis of rotation R. Perpendicular to the axis of rotation R, the boundary members 11, 12 are arranged parallel to each other. The main extension of the boundary members 11, 12 is perpendicular to the axis of rotation R.

The first boundary member 11 has a first texturing surface 15. The first texturing surface 15 is the surface of the boundary member 11 facing the second boundary member 12. The second boundary member 12 has a second texturing surface 16. The second texturing surface 16 is the surface of the boundary member 12 facing the first boundary member 11. The texturing surfaces 15, 16 of the boundary members 11, 12 are designed to be even. The texturing surfaces 15, 16 run parallel to one another in a normal plane of the axis of rotation R. The texturing surfaces 15, 16 extend in a radial direction from the axis of rotation R to a circumferential edge of the boundary members 11, 12. The texturing surfaces 15, 16 enclose an angle b with the axis of rotation R, wherein b=90°. The texturing surfaces 15, 16 run at an angle c with respect to the normal plane of the axis of rotation R, wherein c=90°−b=0°.

A gap 17 is formed between the texturing surfaces 15, 16. The texturing surfaces 15, 16 are spaced apart in the direction of the axis of rotation R. Due to the parallel arrangement of the even texturing surfaces 15, 16, a gap dimension t is constant over the entire area of the texturing surfaces 15, 16. The gap dimension t can be adapted by advancing the boundary members 11, 12 relative to each other, in particular by advancing the rotationally fixed boundary member 11, in the direction of the axis of rotation R. The gap dimension t can have the following dimensions, for example: 5 mm≤t≤20 mm, in particular 8 mm≤t≤15 mm, for example t=10 mm.

The feed opening 10 is formed as a through opening in the boundary member 11. The feed opening 10 is formed as an opening in the boundary member 11 in the region of the axis of rotation R. The feed opening 10 is connected to the supply line 9 in a fluid-conducting manner. The feed opening 10 has a diameter which essentially corresponds to a pipe diameter Dz of the pipe forming the supply line 9. The pipe diameter Dz can assume the following values, for example: 15 mm≤Dz≤100 mm, in particular 17.5 mm≤Dz≤50 mm, for example Dz=20 mm.

The gap 17 is open on the circumferential side. A circumferential discharge opening 18 is formed by the circumferential opening of the gap 17. The discharge opening 18 is spaced further from the axis of rotation R than the feed opening 10. Between the feed opening 10 and the discharge opening 18, the texturing surfaces 15, 16 extend in the radial direction.

A food composition can be continuously fed into the gap 17 via the supply line 9 and the feed opening 10. The food composition passes through, in particular flows through, the gap 17 in a radial direction towards the discharge opening 18. When passing through the gap 17, the food composition interacts with the texturing surfaces 15, 16. The food composition is slowed down due to the contact with the texturing surfaces 15, 16, resulting in a velocity gradient in the gap. This creates a shear within the food composition, which textures the food composition. In particular, a fibrous structure of the food composition develops. On the one hand, the shear is produced by a first shear component due to the passage of the food composition from the feed opening 10 to the discharge opening 18 in the radial direction. Due to simultaneous relative rotational drive of the boundary members 11, 12, an additional second shear component is created, which can be influenced by the rotational drive, in particular by the rotational speed and the direction of rotation. A possible relative rotational speed n can assume the following values, for example: 0·1/min<n≤40·1/min. In particular 5·1/min≤n≤20·1/min, for example 10·1/min.

Furthermore, the texturing of the food composition can be influenced by the size of the texturing surfaces 15, 16 and/or the gap dimension t of the gap 17.

The size of the texturing surfaces 15, 16 essentially results from their extension in the radial direction, which corresponds to a diameter D of the boundary member 12. The boundary member 11 has a slightly larger diameter in the embodiment example shown, but this does not influence the decisive size of the relevant texturing surfaces. For example, the diameter D can be between 200 mm and 3,000 mm, in particular between 250 mm and 2,500 mm, in particular between 500 mm and 2,000 mm Exemplary values for the diameter D are 260 mm, 650 mm, 1,000 mm or 2,300 mm.

The texturing surfaces 15, 16 have a surface profiling in the form of corrugations. The corrugations allow shear forces to be applied particularly efficiently to the food composition in the gap 17. In addition, the surface of the food composition can be textured.

An insert 20 is mounted in a boundary member main body 19 of the boundary member 12. The insert 20 is arranged opposite the feed opening 10. The insert 20 is removably mounted in the boundary member main body 19. The insert 20 can be exchanged. By exchanging the insert 20, different texturing tools can be introduced into the gap 17 to further influence the texturing of the food composition. Using appropriate texturing tools, for example, the flow of the food composition can be directed and split. Suitable texturing tools can, for example, lead to a local tapering of the gap. The texturing tool has, in particular, baffle plates, projections, in particular pins or cones, rakes, grids, filters and/or sieves.

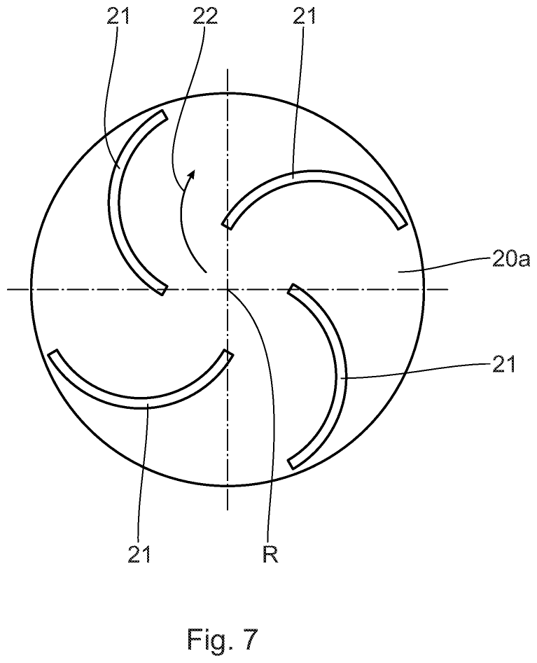

FIG. 7 shows an exemplary insert 20a which includes a texturing tool formed by baffle plates 21. The baffle plates 21 are arranged spirally around the axis of rotation R. The baffle plates 21 enable further mixing of the food composition. In addition, the product shape of the food composition can be influenced by means of the spirally arranged baffle plates 21. When rotating in the direction of the spiral arrangement (clockwise in the arrangement shown in FIG. 7), the food composition is picked up by the spiral arms and conveyed outwards along an arrow 22 shown in FIG. 7 as an example. This results in a rod-like product shape of the food composition. A rotational drive in the direction opposite to the spiral direction of the baffle plates 21 (counterclockwise in FIG. 7) leads to a shearing of the food composition by the baffle plates 21. This further loosens the structure of the food composition. The result is a fragmented and torn product shape of the food composition.

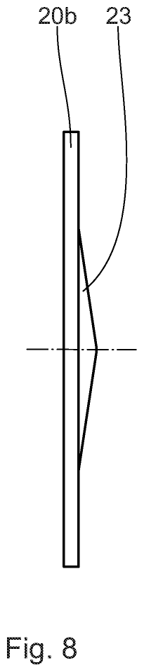

FIG. 8 shows another exemplary embodiment of an insert 20b. The insert 20b has a conical protrusion 23. The conical protrusion 23 narrows the gap dimension opposite the feed opening 10. This results in a counter pressure against the food composition that is continuously fed through the feed opening 10. As a result, the food composition is evenly distributed in the circumferential direction. Due to the decrease of the cone in the radial direction and the increased surface area, the pressure on the food composition is reduced, which favors a loosening of its structure.

The axis of rotation R runs in the direction of gravity. The discharge of the food composition via the gap 17 therefore takes place essentially in the horizontal direction.

The food composition continuously emerges from the outlet opening 18. A wiper device 25 is arranged in the region of the discharge opening 18 for the targeted separation and portioning of the discharged food composition. The wiper device 25 is arranged at the boundary member 11 that is arranged in a rotationally fixed manner With the aid of the wiper device 25, the discharged food composition is detached and collected at a defined circumferential position.

In other embodiments, the discharge opening may be covered by a closure element in the circumferential direction of the gap. One or more openings can be formed in the closure element to ensure a targeted discharge of the food composition, in particular at one or more precisely defined circumferential positions.

Additional access openings 26 are formed in the supply line 9. The access openings 26 are designed as junction or connection pieces. The access openings 26 allow further access to the supply line 9. For example, another component of the food composition that is not provided by the preparation apparatus 2 may be admixed via the access openings 26. For example, there may be a plurality of preparation apparatuses 2 that co-extrude different components of the food composition. Further components of the food composition may be introduced into the supply line 9 via the access openings 26.

Alternatively or additionally, the access provided via the access openings 26 can be used to measure the food composition to be discharged by means of suitable sensors. For example, various sensors can be introduced via the access openings 26 to measure temperature, pressure, density, composition or other parameters of the food composition to be discharged.

The discharge apparatus 3 has a temperature control unit 28 which is not shown in more detail. The temperature control unit 28 serves to control the temperature of the boundary members 11, 12 and thus of the texturing surfaces 15, 16. The temperature control unit 28 has temperature control channels that are formed in the boundary members 11, 12 for a temperature control medium, in particular for a cooling medium. The temperature of the boundary members 11, 12 can be controlled separately from each other, for example in co-flow or counter flow, with the aid of the temperature control channels of the temperature control unit 28. For this purpose, the temperature control unit 28 has a temperature control medium connection 29 and a temperature control medium outlet 30. The temperature control medium, for example cooling water, can be pumped into the temperature control channels that are formed in the boundary members 11, 12 via the temperature control medium connection 29 and the temperature control medium outlet 30.

By controlling the temperature of the boundary members 11, 12, the temperature of a temperature control region of the texturing surfaces 15, 16 is controlled. The temperature control region has a total temperature control area Ak. In embodiments, the temperature control area Ak corresponds essentially to the area of the texturing surfaces 15, 16. The temperature control area Ak has essentially the diameter D for the respective boundary members.

With the aid of the temperature control unit 28, the temperature of the food composition in the gap 17 can be controlled, in particular cooled. The food composition can be hardened by temperature control, in particular by cooling. In embodiments, excessive temperature control, in particular excessive cooling, is avoided in order to prevent the food composition from sticking or freezing to the texturing surfaces 15, 16. A temperature control medium that is used for cooling, for example water or glycol, in particular propylene glycol and/or ethylene glycol, in embodiments has a temperature T for which the following applies: 10° C.≤T≤100° C., in particular 15° C.≤T≤90° C., for example 20° C.≤T≤70° C. This enables gentle cooling of the food composition.

It has proven to be particularly suitable to select the size of the cooling area depending on the hourly flow rate of the food composition. This ensures that the temperature of the food composition can be controlled, in particular cooled, sufficiently even in the case of moderate temperature control, in particular cooling. For example, the following applies to the temperature control area Ak: 40 cm²/(kg/h)≤Ak/m≤1,000 cm²/(kg/h), in particular 200 cm²/(kg/h)≤Ak/m≤800·cm²/(kg/h), in particular 300 cm²/(kg/h)≤Ak/m≤600 cm²/(kg/h), wherein m is the hourly flow rate of the food composition in kilograms.

It has proven to be particularly suitable if the temperature control unit 28 is designed to control the temperature of different temperature control subregions of the texturing surfaces 15, 16. In particular, temperature control can be performed depending on the radial distance from the axis of rotation R. This enables, for example, a gradual cooling of the food composition from the feed opening 10 to the discharge opening 18. Also, the temperature of different temperature control subregions can be controlled differently, e.g. alternating from warm to cold. Different temperature control subregions can be flowed through by the temperature control medium in cross flow, in counter flow and/or in co-flow. It is also possible to cool individual temperature control subregions in an open water bath. This makes it possible to generate a temperature profile along the texturing surfaces 15, 16 that can be specifically adapted to the respective application.

For example, a first temperature control subregion can be formed in a first radius region of the texturing surfaces 15, 16, for example from the center of the texturing surfaces to a fraction of the radius, for example half or one third of the radius. Further temperature control subregions can be formed in adjacent radius regions.

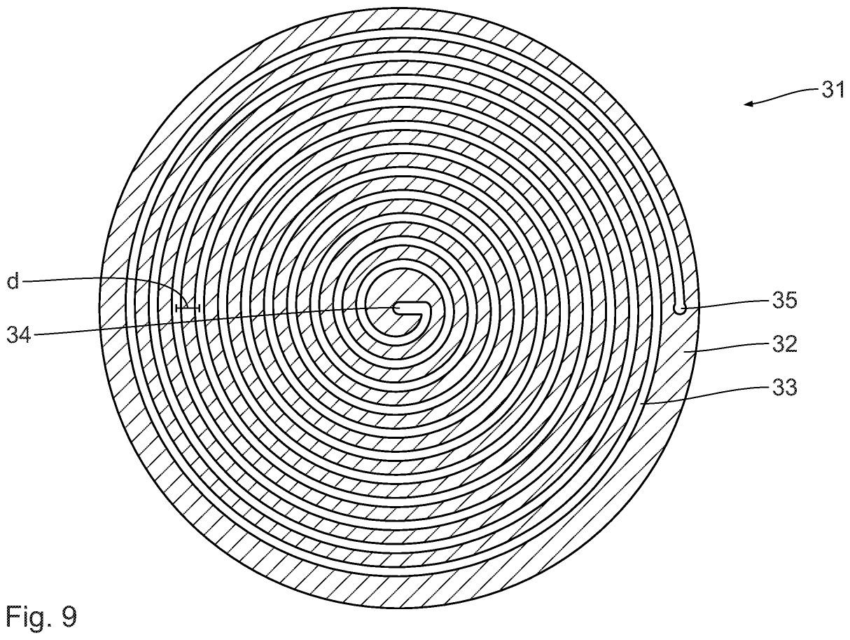

With reference to FIG. 9, the design of a temperature control region in a boundary member 31 is described as an example. FIG. 9 shows a cross-section through an exemplary boundary member 31 with a boundary member main body 32. A temperature control channel 33 for a temperature control medium, in particular a cooling medium, is formed in the boundary member main body 32. The temperature control channel 33 extends spirally from a centrally arranged feeding port 34 to a discharge port 35 arranged at the edge. The temperature control channel 33 revolves around the center of the cross-section several times, wherein a radial offset d is constant between two revolutions. The temperature control channel 33 covers essentially the entire diameter of the boundary member main body 32 evenly. This ensures uniform cooling over the entire texturing surface of the boundary member 31.

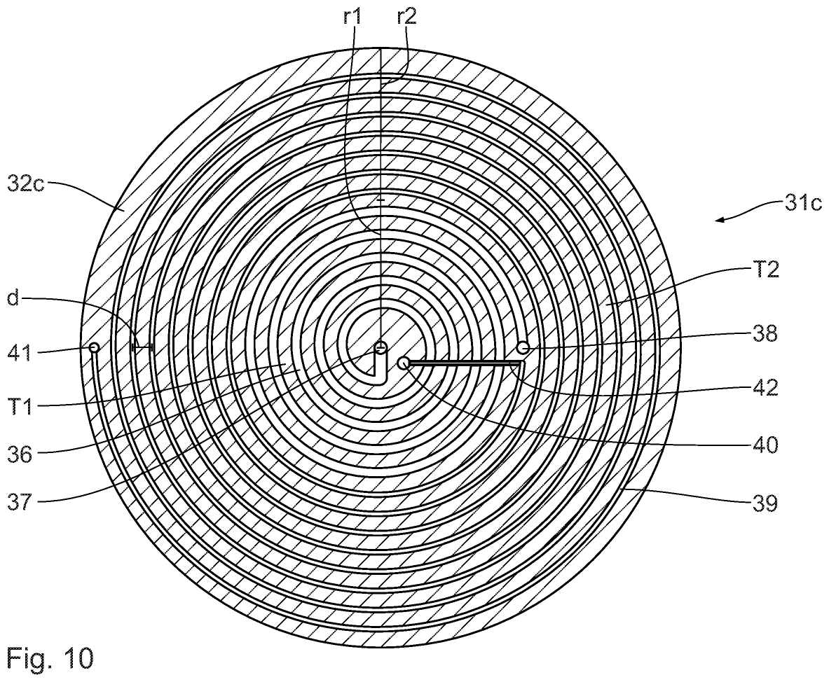

With reference to FIG. 10, the design of a plurality of temperature control subregions T1, T2 of a boundary member 31c is described as an example. Components that have already been described with reference to FIG. 9 bear the same reference signs and will not be explained in detail again. Functionally identical but structurally different components bear the corresponding reference signs with a trailing letter c.

FIG. 10 shows a cross-section through the boundary member 31c. Different temperature control subregions T1, T2 are formed in the boundary member 31c. A first temperature control subregion T1 is formed centrally around the center of the cross-section. It extends from the center of the cross-section to a radius r1. A second temperature control subregion T2 is formed annularly around the first temperature control subregion T1. The second temperature control subregion T2 extends from the radius r1 to the outer circumference of the cross-section of the boundary member 31c. The second temperature control subregion T2 has an annular radius r2.

In the first temperature control subregion T1, a first temperature control channel 36 for a temperature control medium is formed. The temperature control channel 36 runs spirally from a centrally arranged first feeding port 37 to a first discharge port 38.

In the second temperature control subregion T2, a second temperature control channel 39 for a temperature control medium is formed. The second temperature control channel 39 extends spirally over the annular radius r2 from a second feeding port 40 to a second discharge port 41. The second feeding port 40 is arranged in the region of a center of the cross-section. This facilitates the feeding of the temperature control medium via a central rotary connection. A bridging channel 42 is formed between the second feeding port 40 and the spirally formed second temperature control channel 39, which extends essentially in a radial direction. The bridging channel 42 bridges the first temperature control subregion T1 for feeding the temperature control medium into the cooling channel 39 of the second temperature control subregion T2.

The first temperature control channel 36 and the second temperature control channel 39 run in a spiral. The temperature control channels 36, 39 revolve around the center of the cross-section multiple times, wherein a radial offset d is the same for each revolution. The temperature control channels 36, 39 cover the cross-section of the boundary element 31c evenly. The temperature control channels 36, 39 have different channel cross-sections. In the embodiment example shown, the channel cross-section of the temperature control channel 36 is larger than that of the temperature control channel 39. The temperature control channel 36 therefore has a larger throughflow area for the temperature control medium than the temperature control channel 39. The cooling effect is greater in the first temperature control subregion T1 than in the second temperature control subregion T2. As a result, a temperature control gradient is generated in the radial direction. Alternatively or additionally, the temperature control channels 36, 39 can be flowed through by different temperature control media, in particular by differently tempered temperature control media.

In the embodiment example shown in FIG. 10, the temperature control regions T1, T2 have the same extension in the radial direction. In other embodiment examples not shown, the temperature control subregions can cover radial subregions of different sizes. It is also possible to form more than two temperature control subregions. In this manner, a radial course of the temperature control effect can be precisely adjusted.

With regard to the design of the temperature control channels, the first boundary member 11 and/or the second boundary member 12 of the discharge apparatus 3 can be designed like the boundary member 31 in FIG. 9 or the boundary member 31c in FIG. 10. It is also possible that one of the boundary members 11, 12 is designed like the boundary member 31 and the respective other boundary member is designed like the boundary member 31c with regard to the temperature control channels.

In the following, a method for texturing a food composition using the discharge apparatus 3 is described.

The food composition is continuously prepared with the aid of the preparation apparatus 2. For example, the food composition is a so-called High Moisture Meat Analogue (HMMA). Suitable compositions of an HMMA and their preparation are described, for example, in EP 3 270 716 B1.

The prepared food composition is conveyed out of the outlet opening 8 of the extruder 4, in particular in the form of a protein melt, and fed to the supply line 9. The prepared food composition is fed at a pressure p. For example, the following applies to the pressure p: 0 bar<p≤50 bar, in particular 1≤p≤25 bar, for example 3 bar≤p≤20 bar.

The food composition is continuously fed via the feed opening 10 into the gap 17 between the texturing surfaces 15, 16 and passes through the gap 17 in a radial direction from the feed opening 10 to the discharge opening 18. The boundary member 12 is driven in rotation by the rotary drive 14. This results in a relative rotational drive of the boundary members 11, 12 about the axis of rotation R. The relative rotational drive causes a controlled shearing of the food composition in the gap 17.

The temperature of the boundary members 11, 12 is controlled, in particular cooled, by the temperature control unit 28. Different temperature control subregions of the texturing surfaces 15, 16 are tempered differently, in particular in order to achieve a gradual cooling of the food composition from the feed opening 10 to the discharge opening 18. The food composition emerges continuously from the discharge opening 18 and is separated and portioned with the aid of the wiper device 25.

The discharge apparatus 3 therefore serves to continuously discharge the food composition. In particular, the food composition is continuously discharged from the feed opening 10 via the gap 17 and the discharge opening 18. The discharge takes place, for example, at an hourly flow rate m for which applies: 10 kg/h≤m≤2,000 kg/h, in particular 20 kg/h≤m≤1,000 kg/h, in particular 30 kg/h≤m≤500 kg/h.

The discharge apparatus 3 can be easily adapted to the respective application, in particular it is easily scalable. For example, texturing can be obtained by changing the gap dimension t of the gap 17 and/or by changing the relative rotational drive of the boundary members 11, 12, in particular by changing the direction of rotation and/or the relative rotational speed. Additionally or alternatively, in particular a diameter D of the boundary members 11, 12 and thus of the texturing surfaces 15, 16 can be adapted.

In the discharge apparatus 3 shown, the boundary members 11, 12 are designed as parallel plates. The gap dimension t of the gap 17 is therefore constant, in particular independent of a distance to the axis of rotation R. In other embodiment examples, the gap dimension t can vary, in particular be dependent on a distance to the axis of rotation R. For example, the gap dimension t can be increased or decreased with growing distance from the axis of rotation R. As the distance from the rotational axis R increases, the surface speed of the boundary members 11, 12 driven relative to each other increases at constant rotational speed. With growing distance from the axis of rotation R, the shear force induced by the rotational drive therefore increases. By varying the gap dimension t, in particular by increasing the gap dimension t with growing distance from the axis of rotation R, a further parameter for influencing the shear force is available. By increasing the gap dimension t, for example, a rise in the applied shear force with growing distance from the axis of rotation R can be counteracted. By selecting a suitable gap dimension t, a homogeneous shear force can be generated over the entire radius.

In other embodiment examples, for instance, one of the boundary members may be formed as a cone or an inverse cone. In other embodiment examples not shown, both boundary members can be designed to be conical. By choosing the shape of the boundary members, in particular via the shape of the texturing surfaces, the gap dimension and thus the texturing behavior can be adapted in a simple manner.

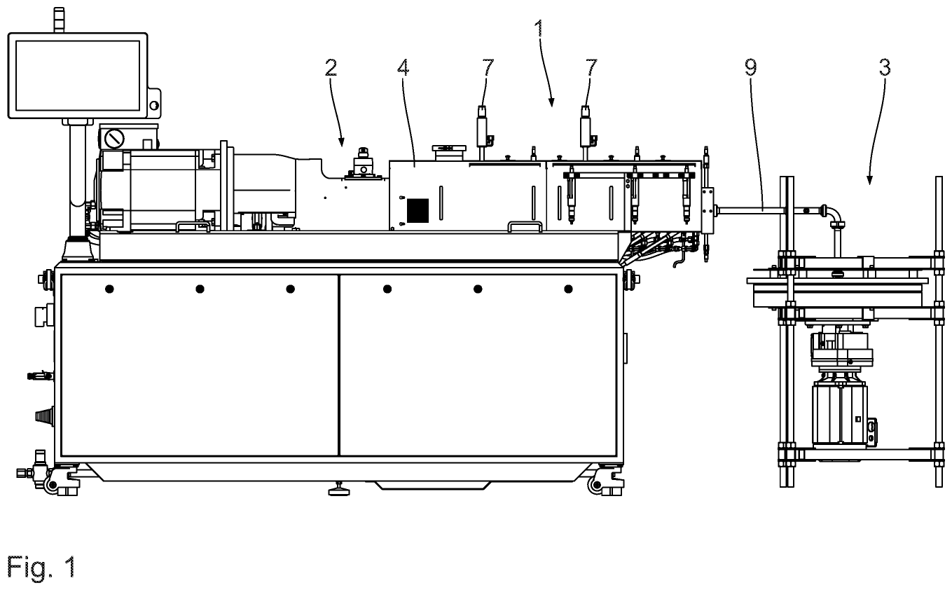

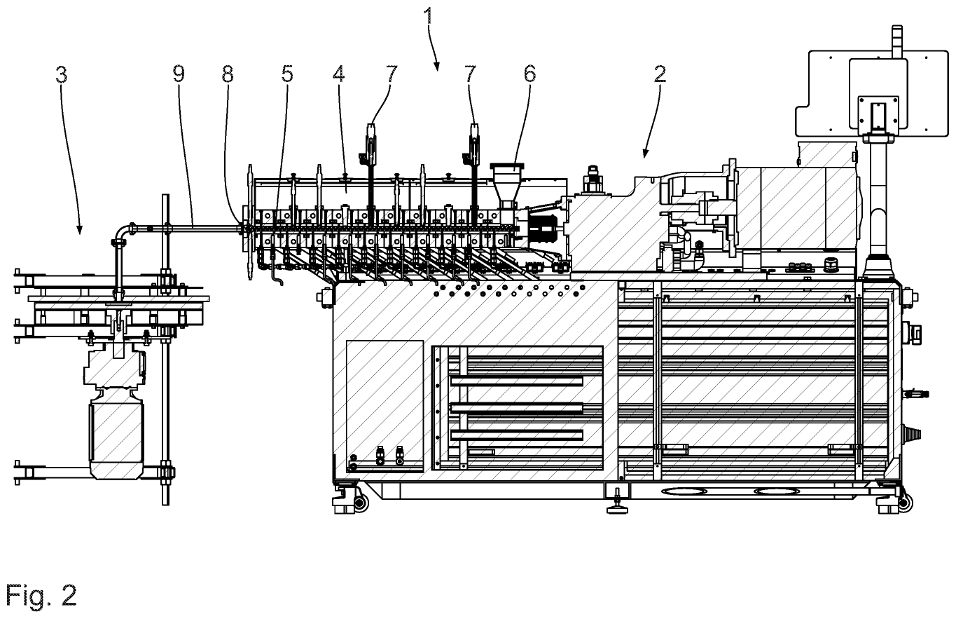

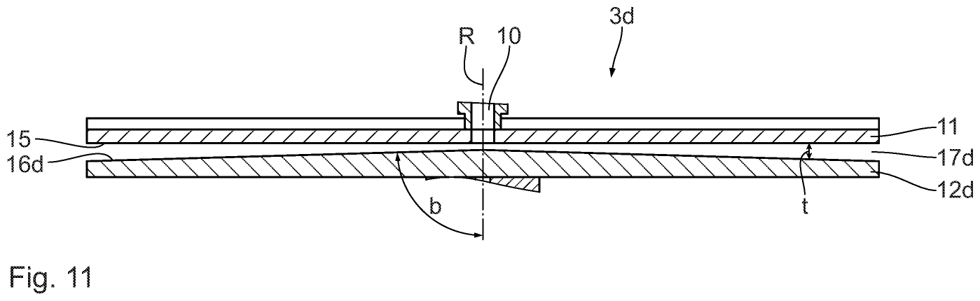

With reference to FIG. 11, a further embodiment example of a discharge apparatus 3d is described. Components that have already been described in relation to FIGS. 1 to 10 bear the same reference signs and are not explained again in detail. Functionally identical but structurally different components bear corresponding reference signs with a trailing letter d.

The discharge apparatus 3d according to FIG. 11 differs from the discharge apparatus 3 of the embodiment example shown in FIGS. 1 to 8 only in the design of the second boundary member 12d. The first boundary member 11 is designed as a circular flat plate. The second boundary member 12d has a circular cross-section perpendicular to the axis of rotation R. The surface of the second boundary member 12d facing the first boundary member 11 is designed to be conical. The angle b between the second texturing surface 16d and the axis of rotation R is less than 90°. In the embodiment example shown, the angle b is about 88°.

Due to the conical design of the second boundary member 12d, the gap 17d formed between the texturing surfaces 15, 16d has a gap dimension t that increases with growing distance from the axis of rotation R.

With regard to the design of the temperature control unit, in particular with regard to the geometry and arrangement of temperature control channels, the boundary members 11, 12d of the discharge apparatus 3d can be designed as shown by the boundary members 31, 31c in FIG. 9 or 10.

In the embodiment examples shown, the boundary members have a circular cross-section perpendicular to the axis of rotation R. In principle, other cross-sections are also conceivable. For example, the boundary members can have polygonal cross-sections. Regular polygonal cross-sections having five or more, in particular 6 or more, in particular eight or more, corners have proven to be particularly suitable.

What is claimed is:

1. A discharge apparatus for texturing a food composition, comprising
a first boundary member having a first texturing surface,
a second boundary member having a second texturing surface,
a gap formed between the first texturing surface and the second texturing surface,
at least one feed opening for continuously feeding the food composition into the gap, and
at least one discharge opening for continuously discharging the food composition from the gap,
wherein the first boundary member and the second boundary member are rotatably drivable relative to each other about an axis of rotation, and
wherein the first texturing surface and the second texturing surface each extend radially to the axis of rotation between the at least one feed opening and the at least one discharge opening.

2. The discharge apparatus according to claim 1, wherein the food composition is a meat substitute composition.

3. The discharge apparatus according to claim 1, wherein at least one of the first texturing surface and the second texturing surface extend at an angle b to the axis of rotation, wherein 45°≤b≤90°.

4. The discharge apparatus according to claim 1, wherein the first texturing surface and the second texturing surface run parallel to one another.

5. The discharge apparatus according to claim 1, wherein a gap dimension of the gap changes depending on a distance to the axis of rotation.

6. The discharge apparatus according to claim 5, wherein the gap dimension of the gap increases with growing distance to the axis of rotation.

7. The discharge apparatus according to claim 1, wherein the at least one discharge opening has a greater distance to the axis of rotation than the at least one feed opening.

8. The discharge apparatus according to claim 1, wherein the at least one discharge opening is formed for discharging the food composition in the direction radial to the axis of rotation.

9. The discharge apparatus according to claim 8, wherein the at least one discharge opening is formed circumferentially between the first boundary member and the second boundary member.

10. The discharge apparatus according to claim 1, comprising at least one wiper device in the region of the at least one discharge opening.

11. The discharge apparatus according to claim 1, comprising at least one texturing tool arranged in the gap.

12. The discharge apparatus according to claim 11, wherein the at least one texturing tool is detachably arranged at least one of at the first boundary member and at the second boundary member.

13. The discharge apparatus according to claim 1, comprising a temperature control unit for temperature control of at least one of the first boundary member and the second boundary member.

14. The discharge apparatus according to claim 13, wherein the temperature control unit controls the temperature of a temperature control region of at least one of the first texturing surface and of the second texturing surface, wherein the temperature control region has a temperature control area Ak for which applies: 40 cm²/(kg/h)≤Ak/m≤1,000 cm²/(kg/h), wherein m is the hourly flow rate of the food composition in kilograms.

15. The discharge apparatus according to claim 13, wherein the temperature control unit is designed for different temperature control of different temperature control subregions of at least one of the first texturing surface and of the second texturing surface.

16. The discharge apparatus according to claim 15, wherein the temperature control unit is designed for temperature control of at least one of the first texturing surface and of the second texturing surface in dependence on a distance from the axis of rotation.

17. The discharge apparatus according to claim 1, wherein at least one of the first texturing surface and the second texturing surface have a surface profiling.

18. The discharge apparatus according to claim 17, wherein at least one of the first texturing surface and the second texturing surface have a corrugation.

19. The discharge apparatus according to claim 1, comprising at least one supply line for continuously supplying the food composition to the at least one feed opening.

20. The discharge apparatus according to claim 1, comprising at least one additional access opening for at least one of the admixture of further ingredients and for monitoring the food composition.

21. A facility for the production of a food composition, comprising:
at least one preparation apparatus for continuously preparing the food composition and
a discharge apparatus for texturing the food composition according to claim 1, wherein at least one outlet opening of the at least one preparation apparatus is connected to the at least one feed opening of the discharge apparatus.

22. The facility according to claim 21, wherein the food composition is a meat substitute composition.

23. A method for texturing a food composition, comprising the steps of
providing a discharge apparatus, comprising:
a first boundary member having a first texturing surface,
a second boundary member having a second texturing surface,
a gap formed between the first texturing surface and the second texturing surface,
at least one feed opening to the gap, and
at least one discharge opening from the gap,
wherein the first boundary member and the second boundary member are rotatably drivable relative to each other about an axis of rotation,
wherein the first texturing surface and the second texturing surface each extend radially to the axis of rotation between the at least one feed opening and the at least one discharge opening,
continuously feeding a food composition to be textured into the gap of the discharge apparatus via the at least one feed opening,
rotationally driving the first boundary member and the second boundary member relative to each other to produce shear forces on the food composition located in the gap to texture it,
continuously discharging the textured food composition via the at least one discharge opening.

24. The method according to claim 23, wherein the food composition is a meat substitute composition.

25. The method according to claim 23, wherein the first boundary member and the second boundary member are rotationally driven relative to each other such that for a relative rotational speed n: 0·1/min<n≤40·1/min.

26. The method according to claim 23, wherein a direction of rotation with which the first boundary member and the second boundary member are driven in rotation relative to each other is inverted during the discharge process.

27. The method according to claim 26, wherein the direction of rotation with which the first boundary member and the second boundary member are driven in rotation relative to each other is inverted repeatedly.

28. The method according to claim 23, wherein the food composition is fed at a pressure p via the feed opening, wherein the following applies to the pressure p: 0 bar<p≤50 bar.

29. The method according to claim 23, wherein the textured food composition is discharged at a flow rate m via the at least one discharge opening, wherein: 10 kg/h≤m≤2,000 kg/h.

30. The method according to claim 23, wherein different temperature control subregions of at least one of the first texturing surface and of the second texturing surface are controlled differently.

31. The method according to claim 30, wherein different temperature control subregions of at least one of the first texturing surface and of the second texturing surface are controlled in dependence on a distance from the axis of rotation.
